(19) United States
(12) Patent Application Publication
(10) Pub. No.: US 2016/0102580 A1
(43) Pub. Date: Apr. 14, 2016

(54) POWER TURBINE INLET DUCT LIP

(71) Applicant: PW POWER SYSTEMS, INC., Glastonbury, CT (US)

(72) Inventors: Fabian D. Betancourt, Meriden, CT (US); Fernando K. Grant, South Windsor, CT (US); Andrew P. Boursy, Marlborough, CT (US); Alexander Sankovich, Hebron, CT (US); Charles C. Wu, Glastonbury, CT (US)

(21) Appl. No.: 14/512,536

(22) Filed: Oct. 13, 2014

(51) Int. Cl. F01D 25/26; F01D 9/04; F02C 3/10

(52) U.S. Cl. CPC F01D 25/26; F02C 3/10; F01D 9/041; F05D 2240/50; F05D 2250/141

(57) ABSTRACT

A power turbine section for a gas turbine engine includes an inlet duct upstream of a first power turbine vane array, the inlet duct including a lip.

### BACKGROUND

The present disclosure relates to a gas turbine engine and, more particularly, to a power turbine section therefor.

In a gas turbine engine, such as a large frame heavy-duty industrial gas turbine (IGT) engine, a core gas stream generated in a gas generator section is passed through a power turbine section to produce mechanical work. The power turbine includes one or more rows, or stages, of stator vanes and rotor blades that react with the core gas stream.

Interaction of the core gas stream with the power turbine hardware may result in the hardware being subjected to temperatures beyond the design points. Over time, such temperatures may reduce the life of the power turbine at the junction between the gas generator section and the power turbine section.

### SUMMARY

A power turbine section for a gas turbine engine according to one disclosed non-limiting embodiment of the present disclosure includes a first power turbine vane array; and an inlet duct upstream of said first power turbine vane array, said inlet duct including an annular inner duct wall spaced from an annular outer duct wall, said annular inner duct wall including a lip.

A further embodiment of the present disclosure includes, wherein said lip extends from a gas path surface of said annular inner duct wall.

A further embodiment of any of the foregoing embodiments of the present disclosure includes, wherein said lip defines a ramp.

A further embodiment of any of the foregoing embodiments of the present disclosure includes, wherein said ramp defines an angle of about ten (10) degrees with respect to a gas path surface.

A further embodiment of any of the foregoing embodiments of the present disclosure includes, wherein said lip is defines a downstream edge of said annular inner duct wall.

A further embodiment of any of the foregoing embodiments of the present disclosure includes, wherein said downstream edge of said annular inner duct wall at least partially axially overlaps a mount lug of said first power turbine vane array, said mount lug receivable into a bearing support.

A further embodiment of any of the foregoing embodiments of the present disclosure includes, wherein said inlet duct generally forms a frustoconical shape.

A further embodiment of any of the foregoing embodiments of the present disclosure includes, wherein an upstream edge of said annular inner duct wall and said annular outer duct wall are radially inboard of a respective downstream edge of said annular inner duct wall and said annular outer duct wall.

A further embodiment of any of the foregoing embodiments of the present disclosure includes an inlet case that supports said first power turbine vane array and said inlet duct upstream.

A further embodiment of any of the foregoing embodiments of the present disclosure includes an air strut that extends through said inlet case and said inlet duct.

A further embodiment of any of the foregoing embodiments of the present disclosure includes, wherein said air strut extends through said inlet duct aft of an upstream edge and forward of a downstream edge of said inlet duct.

A gas turbine engine according to another disclosed non-limiting embodiment of the present disclosure includes a gas generator section and a power turbine section driven by said gas generator section, said power turbine section including an inlet duct, said inlet duct including an annular inner duct wall spaced from an annular outer duct wall, said annular inner duct wall including a lip.

A further embodiment of any of the foregoing embodiments of the present disclosure includes, a first power turbine vane array, said inlet duct upstream of said first power turbine vane array.

A further embodiment of any of the foregoing embodiments of the present disclosure includes, wherein said lip extends from a gas path surface of said annular inner duct wall.

A further embodiment of any of the foregoing embodiments of the present disclosure includes, wherein said lip defines a ramp.

A further embodiment of any of the foregoing embodiments of the present disclosure includes, wherein said ramp defines an angle of about ten (10) degrees with respect to said gas path surface.

A further embodiment of any of the foregoing embodiments of the present disclosure includes, wherein said lip defines a downstream edge of said annular inner duct wall

A further embodiment of any of the foregoing embodiments of the present disclosure includes, wherein said downstream edge of said annular inner duct wall at least partially axially overlaps a mount lug of a first power turbine vane array, said mount lug receivable into a bearing support.

A further embodiment of any of the foregoing embodiments of the present disclosure includes, wherein said bearing support is a #7 bearing support.

A further embodiment of any of the foregoing embodiments of the present disclosure includes, wherein said gas turbine engine is an industrial gas turbine engine within a ground mounted enclosure.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic view of an example gas turbine engine architecture;

FIG. 2 is a schematic view of an example gas turbine engine in an industrial gas turbine environment;

FIG. 3 is a perspective view of a power turbine inlet;

FIG. 4 is a lateral schematic sectional view of power turbine inlet;

FIG. 5 is an expanded schematic sectional view of the power turbine inlet;

FIG. 6 is an expanded schematic sectional view of an inlet duct of the power turbine inlet according to one disclosed non-limiting embodiment;

FIG. 7 is an expanded schematic sectional view of an inlet duct; and

FIG. 8 is an expanded schematic sectional view of a RELATED ART inlet duct.

### DETAILED DESCRIPTION

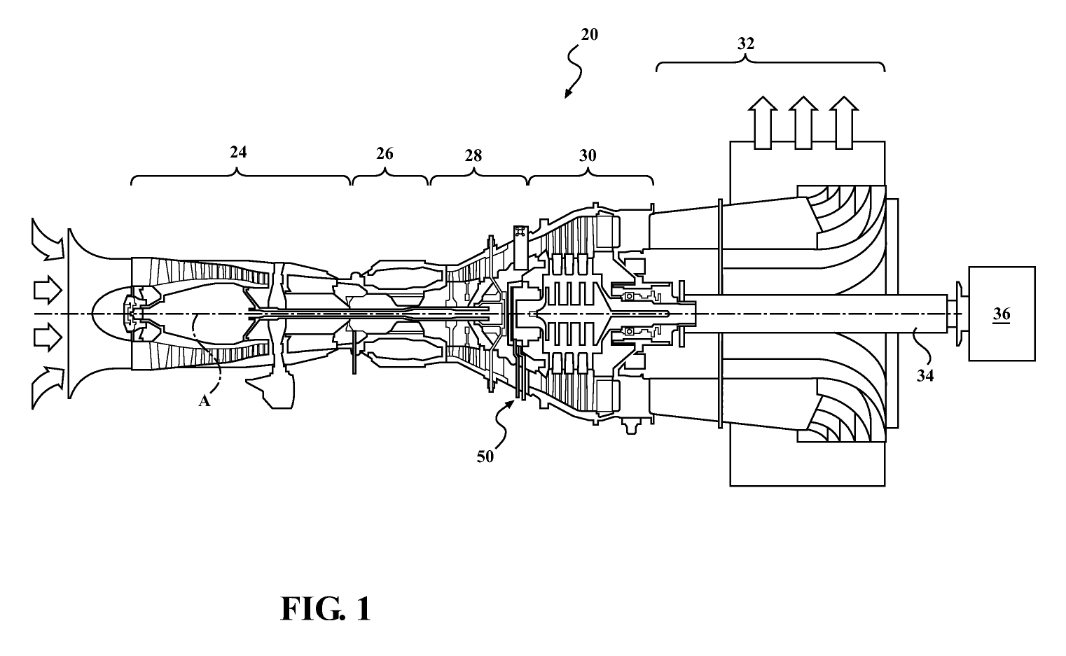

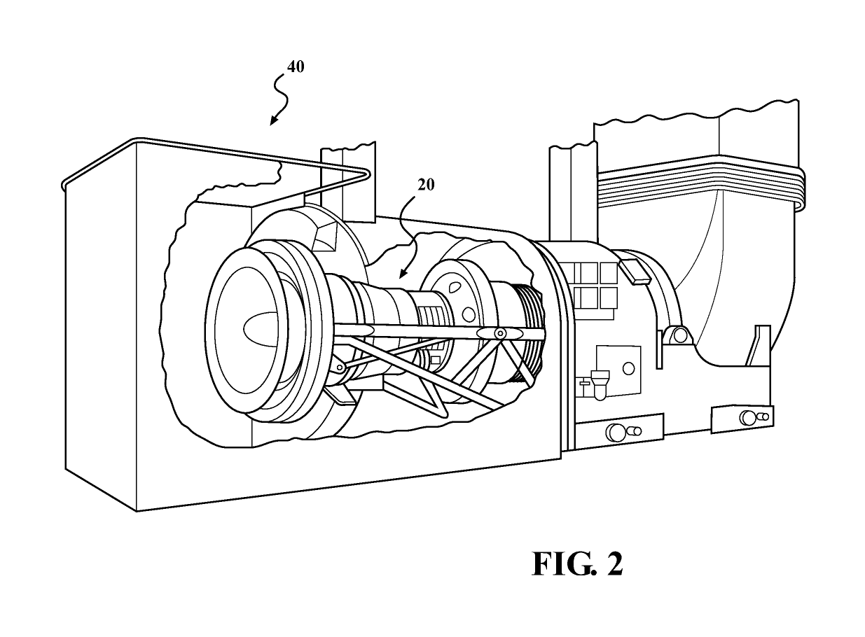

FIG. 1 schematically illustrates a gas turbine engine 20. The gas turbine engine 20 generally includes a compressor section 24, a combustor section 26, a turbine section 28, a power turbine section 30, and an exhaust section 32. The engine 20 may be situated within a ground mounted enclosure 40 (FIG. 2) typical of an industrial gas turbine (IGT). Although depicted as specific engine architecture in the disclosed non-limiting embodiment, it should be understood that the concepts described herein are not limited to only such architecture as the teachings may be applied to other gas turbine architectures.

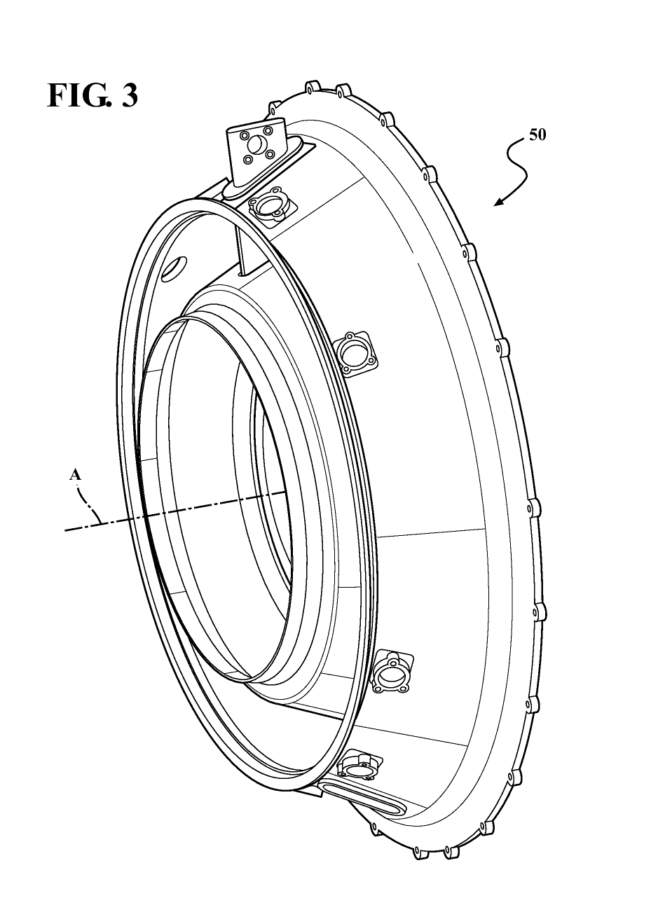

The compressor section 24, the combustor section 26, and the turbine section 28 is commonly referred to as the gas generator section to drive the power turbine section 30. The power turbine section 30 drives an output shaft 34 to power a generator 36 or other system. The power turbine section 30 generally includes a power turbine inlet 50 (FIG. 3) that communicates the core gas stream from the turbine section 28 of the gas generator into the one or more rows, or stages, of stator vanes and rotor blades.

With reference to FIG. 4, the power turbine inlet 50 generally includes an inlet case 52, an inlet duct 54, an air strut 56, a bearing support 58 and a first power turbine vane array 60. The inlet duct 54 is mounted to the inlet case 52 and the bearing support 58 to guide the core gas stream to the first power turbine vane array 60 mounted between the inlet case 52 and the bearing support 58. The engine 20 generally includes a multiple of bearing supports 58 to radially support the rotational hardware for rotation about an engine central longitudinal axis A. In this disclosed non-limiting embodiment, the bearing support 58 in the power turbine inlet 50 is the #7 bearing support in the engine 20.

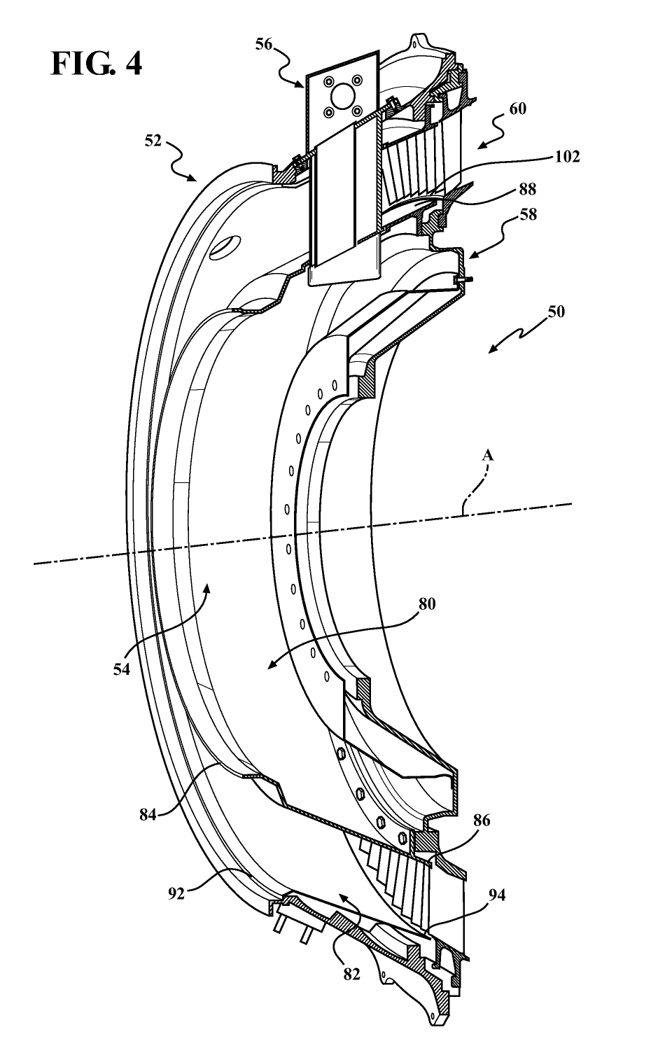

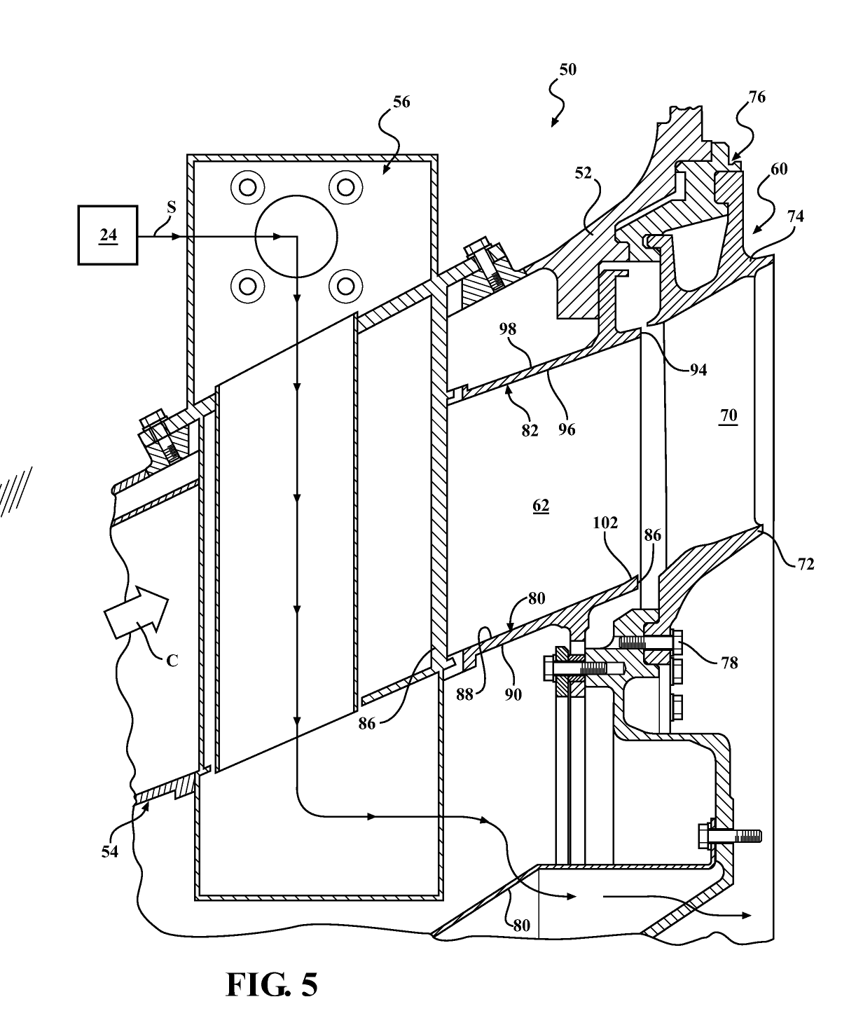

With reference to FIG. 5, the first power turbine vane array 60 generally includes an array of airfoils 70 that extend between a respective inner vane platform 72 and an outer vane platform 74. The outer vane platforms 74 may be mounted to the inlet case 52 via a hook and lug arrangement 76 and the inner vane platform 72 may be mounted to the bearing support 58 via fasteners 78 such as bolts.

The respective inner vane platform 72 and the outer vane platform 74 at least partially bound a core gas path flow C along a core gas path 62 inclusive of the airfoils 70. The air strut 56 communicates a secondary cooling airflow “S” from, for example, the compressor section 24 to cool hardware in the rotor and bearing compartment of the power turbine section 30. In this disclosed non-limiting embodiment, the secondary cooling airflow

“S” flows through the annular inner duct wall 80, then through the bearing support 58. It should be appreciated that various apertures, and metering features may be provided within the annular inner duct wall 80 and/or the bearing support 58 to control the secondary cooling airflow “S”.

The inlet duct 54 generally includes an annular inner duct wall 80 and an annular outer duct wall 82. The annular inner duct wall 80 includes an upstream edge 84 (FIG. 4), a downstream edge 86, a gas path surface 88, and a non-gas path surface 90. The annular outer wall 82 includes an upstream edge 92 (FIG. 4), a downstream edge 94, a gas path surface 96, and a non-gas path surface 98. The upstream edges 84, 92 are radially inboard of the downstream edges 86, 94 such that the inlet duct 54 generally forms a frustoconical shape (FIG. 4).

The air strut 56 extends through the inlet duct 54 aft of the upstream edges 84, 92 and fore of the downstream edges 86, 94. It should be appreciated that “fore” and “aft” as described herein are with respect with the core airflow C through the engine 20 from the compressor section 24 to the exhaust section 32. The downstream edges 86, 94 are upstream of the respective inner vane platform 72 and the outer vane platform 74. The annular inner duct wall 80 and the annular outer duct wall 82 are spaced to generally correspond with the span of the airfoils 70.

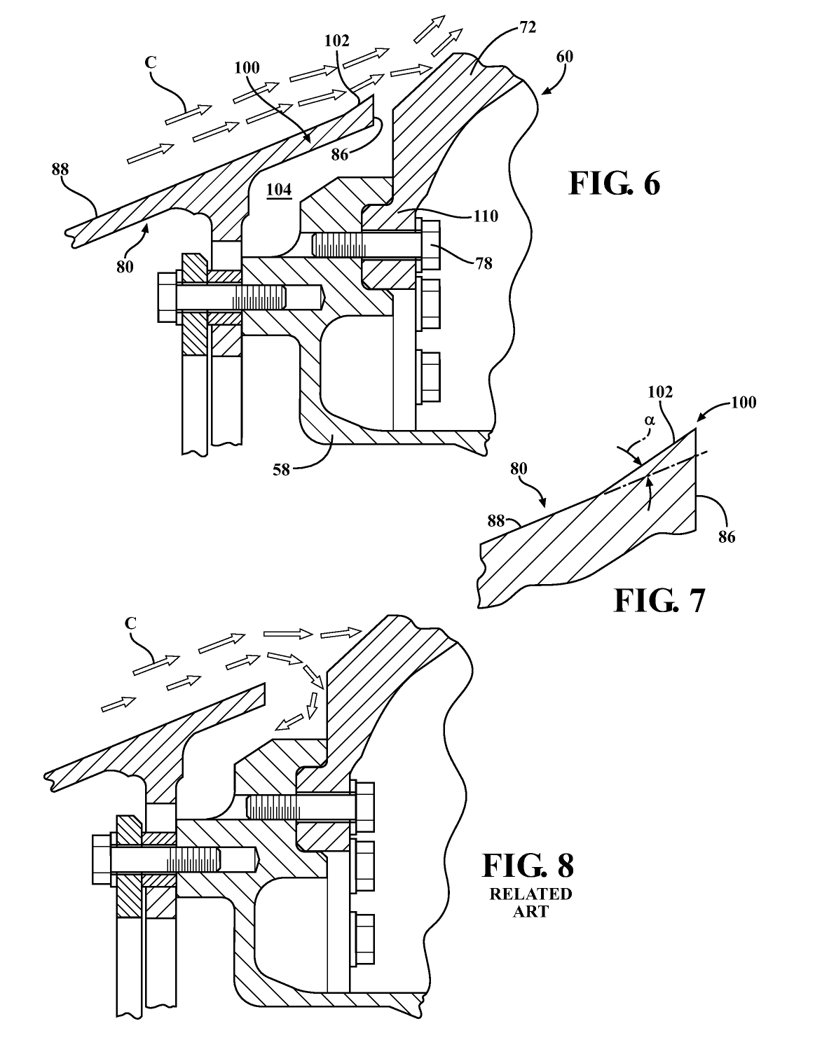

With reference to FIG. 6, the downstream edge 86 of the annular inner duct wall 80 includes a lip 100 along the gas path surface 88. As defined herein a “lip” is a raised area adjacent to the edge of the annular inner duct wall 80. In one disclosed non-limiting embodiment, the lip 100 at least partially forms a ramp 102 that defines an angle a (FIG. 7) of, for example, about ten (10) degrees with respect to the gas path surface 88. It should be appreciated that various angles and shapes may alternatively be provided. The lip 100, in this disclosed non-limiting embodiment, is directly upstream of the first power turbine vane array 60 which is the first array immediately downstream of the annular inner duct wall 80. That is, the lip 100 is located at an interface between the annular inner duct wall 80 the first power turbine vane array 60.

The lip 100 facilitates direction of the core gas stream with respect to the inner vane platform 72 to minimize the entry of the core gas path flow C into an inner cavity 104 to minimize the thermal stresses otherwise applied to the bearing support 58 as compared to a conventional edge (RELATED ART; FIG. 8). The ramp 102 is operable to further guide core gas path flow C over a high pressure, stagnation point, that typically forms forward of the inner vane platform 72 that otherwise forces gas path air into a cavity not intended to receive the core gas path flow C gas and the associated high temperatures therefrom. The ramp 102 thereby minimizes the gas path air that interacts with the high pressure zone, and minimizes—if not eliminates—entry of core gas path flow C into the un-cooled cavity.

The lip 100 of the downstream edge 86 of the annular inner duct wall 80 also extends toward the respective inner vane platform 72 to at least partially axially overlap a mount lug 110 of the first power turbine vane array 60 that is received into the bearing support 58. The lip 100 thereby further minimizes ingestion of the core gas path flow C as compared to the conventional edge (RELATED ART; FIG. 8).

The use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other. It should be appreciated that relative positional terms such as “forward,” “aft,” “upper,” “lower,” “above,” “below,” and the like are with reference to the normal operational attitude and should not be considered otherwise limiting.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed:

1. A power turbine section for a gas turbine engine comprising:
a first power turbine vane array; and
an inlet duct upstream of said first power turbine vane array, said inlet duct including an annular inner duct wall spaced from an annular outer duct wall, said annular inner duct wall including a lip.

2. The power turbine section as recited in claim 1, wherein said lip extends from a gas path surface of said annular inner duct wall.

3. The power turbine section as recited in claim 1, wherein said lip defines a ramp.

4. The power turbine section as recited in claim 3, wherein said ramp defines an angle of about ten (10) degrees with respect to a gas path surface.

5. The power turbine section as recited in claim 1, wherein said lip defines a downstream edge of said annular inner duct wall.

6. The power turbine section as recited in claim 5, wherein said downstream edge of said annular inner duct wall at least partially axially overlaps a mount lug of said first power turbine vane array, said mount lug receivable into a bearing support.

7. The power turbine section as recited in claim 1, wherein said inlet duct generally forms a frustoconical shape.

8. The power turbine section as recited in claim 7, wherein an upstream edge of said annular inner duct wall and said annular outer duct wall are radially inboard of a respective downstream edge of said annular inner duct wall and said annular outer duct wall.

9. The power turbine section as recited in claim 1, further comprising an inlet case that supports said first power turbine vane array and said inlet duct upstream.

10. The power turbine section as recited in claim 9, further comprising an air strut that extends through said inlet case and said inlet duct.

11. The power turbine section as recited in claim 10, wherein said air strut extends through said inlet duct aft of an upstream edge and forward of a downstream edge of said inlet duct.

12. A gas turbine engine comprising:
a gas generator section; and
a power turbine section driven by said gas generator section, said power turbine section including an inlet duct, said inlet duct including an annular inner duct wall spaced from an annular outer duct wall, said annular inner duct wall including a lip.

13. The gas turbine engine as recited in claim 12, further comprising a first power turbine vane array, said inlet duct upstream of said first power turbine vane array.

14. The gas turbine engine as recited in claim 12, wherein said lip extends from a gas path surface of said annular inner duct wall.

15. The gas turbine engine as recited in claim 14, wherein said lip defines a ramp.

16. The gas turbine engine as recited in claim 15, wherein said ramp defines an angle of about ten (10) degrees with respect to said gas path surface.

17. The gas turbine engine as recited in claim 14, wherein said lip defines a downstream edge of said annular inner duct wall

18. The gas turbine engine as recited in claim 17, wherein said downstream edge of said annular inner duct wall at least partially axially overlaps a mount lug of a first power turbine vane array, said mount lug receivable into a bearing support.

19. The gas turbine engine as recited in claim 18, wherein said bearing support is a #7 bearing support.

20. The gas turbine engine as recited in claim 18, wherein said gas turbine engine is an industrial gas turbine engine within a ground mounted enclosure.
